(19) United States
(12) Patent Application Publication
(10) Pub. No.: US 2023/0058986 A1
(43) Pub. Date: Feb. 23, 2023

(54) SYSTEMS AND METHODS FOR DETERMINING TIRE CHARACTERISTICS USING AN ELECTRIC VEHICLE CHARGING STATION

(71) Applicant: Volta Charging, LLC, San Francisco, CA (US)

(72) Inventors: Ionel-Alexandru Hosu, Bucharest (RO); David Klein, Los Altos, CA (US); Bradford Crist, San Francisco, CA (US); Praveen Mandal, San Francisco, CA (US)

(21) Appl. No.: 17/892,972

(22) Filed: Aug. 22, 2022

Related U.S. Application Data
(60) Provisional application No. 63/236,086, filed on Aug. 23, 2021.

(51) Int. Cl. B60L 53/30; G06T 7/00; B60L 53/66; B60L 53/65; B60R 16/023

(52) U.S. Cl. CPC B60L 53/305; G06T 7/0002; B60L 53/66; B60L 53/65; B60R 16/0234; B60L 2250/16; G06T 2207/30252

(57) ABSTRACT

Systems and methods are provided herein for determining a tire characteristic of an electric vehicle's tires and notifying a user of the tire characteristic. This may be accomplished by an electric vehicle charging station (EVCS) receiving an image of an electric vehicle in response to detecting the electric vehicle. The EVCS can use the received image to determine a tire characteristic (e.g., tire tread depth) of one or more tires of the electric vehicle. The EVCS can then notify the user of the electric vehicle. For example, the EVCS may display a notification on a display of the EVCS. The EVCS may also recommend one or more locations where a user can take the electric vehicle to have the one or more tires serviced.

### BACKGROUND

The present disclosure relates to computer-implemented techniques for charging electric vehicles, and in particular to techniques for allocating resources to electric vehicles based on information corresponding to the electric vehicle's tires.

### SUMMARY

As more consumers transition to electric vehicles, there is an increasing demand for electric vehicle charging stations (EVCSs). These EVCSs usually supply electric energy, either using cables or wirelessly, to the batteries of electric vehicles. For example, a user can connect their electric vehicle via cables of an EVCS and the EVCS supplies electrical current to the user's electric vehicle. The cables and control systems of the EVCSs can be housed in kiosks in locations to allow a driver of an electric vehicle to park the electric vehicle close to the EVCS and begin the charging process. These kiosks may be placed in areas of convenience, such as in parking lots at shopping centers, in front of commercial buildings, or in other public places. These kiosks often comprise a display that can be used to provide media items to the user to enhance the user's charging experience. Consequently, passersby, in addition to users of the EVCS, may notice media items displayed by the EVCS. Traditionally, EVCSs provide the same services (e.g., user experience, charging rate, charging cost, etc.) to each electric vehicle that is connected to the EVCSs without considering additional factors (e.g., tire characteristics, inferred dwell time, electrical grid load, etc.), which results in suboptimal user experience.

Tire characteristics relate to characteristics (e.g., tread depth, tire type, etc.) of the tire of a vehicle (e.g., electric vehicle). There are many different tires with different tread styles and/or tread types (e.g., directional, symmetrical, asymmetrical, etc.). Many of these tires are associated with certain makes and models of vehicles. The condition of the tire tread often corresponds to the depth of the tire tread. The depth of the tire tread can have a significant impact on a vehicle's stopping distance and handling. Insufficient tire tread can result in higher chances of collisions, and many states have laws requiring a minimum tire tread (e.g., more than 1.58 millimeters (mm) of tread depth). Many vehicle owners forget to regularly check the tire tread depth of their vehicle's tires. Of the owners who do check their tire tread depth, they can often experience difficulties in determining accurate measurements. For example, some owners employ methodologies (e.g., using a coin) to measure tire tread depth, wherein the methodologies can be imprecise and/or may be improperly executed. Even if vehicle owners are able to accurately determine whether they need new tires based on the tire tread depth, it can be challenging for the vehicle owners to determine the type of tire they need. For example, vehicle owners do not always know what type of tires their vehicle uses, so determining the correct type of replacement tires often requires research, guesswork, and/or visiting a tire service center to consult an auto service specialist. Accordingly, current techniques lack an efficient methodology for determining tire tread depth of a vehicle.

Various systems and methods described herein address these problems by providing a method for determining a tire characteristic of an electric vehicle's tires and notifying a user of the tire characteristic. As described herein, one methodology to determine a tire characteristic of an electric vehicle is for an EVCS to use one or more sensors to capture information (e.g., video, photos, etc.) about the electric vehicle. For example, the EVCS may use one or more cameras to capture images of an electric vehicle's tire(s). The EVCS may capture the images of the electric vehicle's tire in response to an event (e.g., the EVCS determining that an electric vehicle is within a vicinity of the EVCS, a user requesting tire tread information, an electric vehicle requesting charging, etc.). The EVCS can use the one or more images of the electric vehicle's tire to determine a tire characteristic. In some applications, such as described in U.S. application Ser. No. 63/177,787, the entire disclosure of which is hereby incorporated by reference herein in its entirety, machine learning algorithms can be used to determine tire characteristics. For example, the EVCS can determine a tire characteristic (e.g., depth of the tire tread, tire condition, etc.) using a machine learning algorithm trained using a database comprising a plurality of tire images wherein the images indicate tire characteristic (e.g., depth of the tire tread, tire condition, etc.) of a tire shown in the image. The tire characteristics indicated by the plurality of images can correlate to other tire characteristics (e.g., tire labeled as “worn” is correlated to low tire tread depth (e.g., less than two millimeters) and/or a tire that shows signs of wear (e.g., balding)). The EVCS can notify the user of the electric vehicle of the determined tire characteristic. For example, the EVCS may display the tire characteristic on the display of the EVCS for the user to see. In another example, the EVCS may send a notification to a device associated with the user, wherein the notification indicates the tire characteristic.

The EVCS can use the determined tire characteristic to determine a tire condition for the user. For example, the EVCS may determine that a tire with a tire tread depth (tire characteristic) over six millimeters is in a “good” condition. The EVCS may determine that a tire with a tire tread depth between six millimeters and three millimeters is in an “ok” condition. The EVCS may determine that a tire with a tire tread depth below three millimeters is in a “worn” condition and should be replaced soon. The EVCS can notify the user of the electric vehicle of the tire condition allowing the user to quickly and easily discern their vehicle's tire condition. In some cases (e.g., when the tire condition is “worn”), the EVCS includes a suggestion (e.g., replace tires soon) in conjunction with the notification indicating the condition of the tire. Although “good,” “ok,” and “worn,” are listed, any similar such categories and tire tread depths can be used. For example, “bald” may correspond to under two millimeters, “worn” may correspond to between two millimeters and four millimeters, “ok” may correspond to between four millimeters and six millimeters, and “good” may correspond to more than six millimeters.

The EVCS may determine the type of tire based on the one or more images of an electric vehicle's tire. For example, the EVCS may determine that the tire is a 235/45R18 Michelin Primacy MXM4 tire because the one or more images show the size, pattern, texture, shape, Department of Transportation (DOT) serial number, etc., of the tire, which correspond to the 235/45R18 Michelin Primacy MXM4 tire. In response to determining the tire characteristic (e.g., the tire is a 235/45R18 Michelin Primacy MXM4 tire), the EVCS can make customized suggestions to the user. For example, the EVCS can send a notification indicating the tire type and a suggestion to buy new tires. The EVCS can also send a notification indicating sales and/or locations that offer the same or similar tire types as the tires on the user's electric vehicle. The EVCS may also use vehicle characteristics (e.g., vehicle model, vehicle make, vehicle condition, etc.) to aid in determining tire characteristics. For example, the EVCS may use one or more cameras to capture images of the electric vehicle and use the captured images to determine the make and model (e.g., 2017 Tesla Model 3) of the electric vehicle. The EVCS can then access a database comprising entries linking makes and models of electric vehicles to tire types. The EVCS can use the database and the vehicle characteristics (e.g., 2017 Tesla Model 3) to determine the tire type (e.g., 235/45R18 Michelin Primacy MXM4) of the electric vehicle.

The EVCS can store vehicle information related to the electric vehicle in a profile associated with the electric vehicle. For example, the EVCS may store tire characteristics and/or vehicle characteristics in a database that associates a user and/or a user's vehicle with vehicle information. The EVCS may use the profile to more quickly and/or accurately determine tire characteristics for an electric vehicle during charging events. For example, when an electric vehicle requests charging from an EVCS, the EVCS may receive tire characteristics associated with the electric vehicle from the last time the electric vehicle requested charging. The EVCS can use the previous tire characteristics (e.g., tire type) to more quickly determine the condition of the tire, because the EVCS does not have to compare the electric vehicle's tire with different tire types. The EVCS can also use differences in data collected between charging events to determine estimated vehicle information. For example, based on the change in tire tread (e.g., tire tread decreased by two millimeters) between two charging events, the EVCS can estimate the distance the electric vehicle traveled during the time period between the two charging events. The EVCS can use the estimated vehicle information (e.g., distance traveled) to customize notifications and media items for display by the EVCS. For example, if the EVCS determines, based on the estimated amount of miles traveled by an electric vehicle (estimated vehicle information), that the user of the electric vehicle will need to service their electric vehicle soon, the EVCS can recommend that the user schedule a service appointment in the upcoming weeks.

The EVCS can leverage machine learning to identify tire characteristics, electric vehicle characteristics, estimated vehicle information, and/or similar such information. The EVCS can use any combination of tire characteristics, user information, electric vehicle characteristics, location information, and similar such information to send notifications to the user and/or to determine media items to display.

### BRIEF DESCRIPTION OF THE DRAWINGS

The below and other objects and advantages of the disclosure will be apparent upon consideration of the following detailed description, taken in conjunction with the accompanying drawings and in which:

FIGS. 1A and 1B show an illustrative diagram of a system for determining a tire characteristic of an electric vehicle's tire and notifying a user of the tire characteristic, in accordance with some embodiments of the disclosure;

FIGS. 2A-2D show illustrative diagrams for determining a tire characteristic of an electric vehicle's tire and notifying a user of the tire characteristic, in accordance with some embodiments of the disclosure;

FIGS. 3A and 3B illustrate an EVCS used for determining a tire characteristic of an electric vehicle's tire and notifying a user of the tire characteristic, in accordance with some embodiments of the disclosure;

FIG. 4 shows an illustrative block diagram of an EVCS system, in accordance with some embodiments of the disclosure;

FIG. 5 shows an illustrative block diagram of a user equipment device system, in accordance with some embodiments of the disclosure;

FIG. 6 shows an illustrative block diagram of a server system, in accordance with some embodiments of the disclosure;

FIG. 7 is an illustrative flowchart of a process for determining a tire characteristic of an electric vehicle's tires and notifying a user of the tire characteristic, in accordance with some embodiments of the disclosure;

FIG. 8 is another illustrative flowchart of a process for determining a tire characteristic of an electric vehicle's tire and notifying a user of the tire characteristic, in accordance with some embodiments of the disclosure;

FIG. 9 is another illustrative flowchart of a process for determining a tire characteristic of an electric vehicle's tire and notifying a user of the tire characteristic, in accordance with some embodiments of the disclosure; and

FIGS. 10A-10D show an illustrative process for determining a tire characteristic of an electric vehicle's tire and notifying a user of the tire characteristic, in accordance with some embodiments of the disclosure.

### DETAILED DESCRIPTION

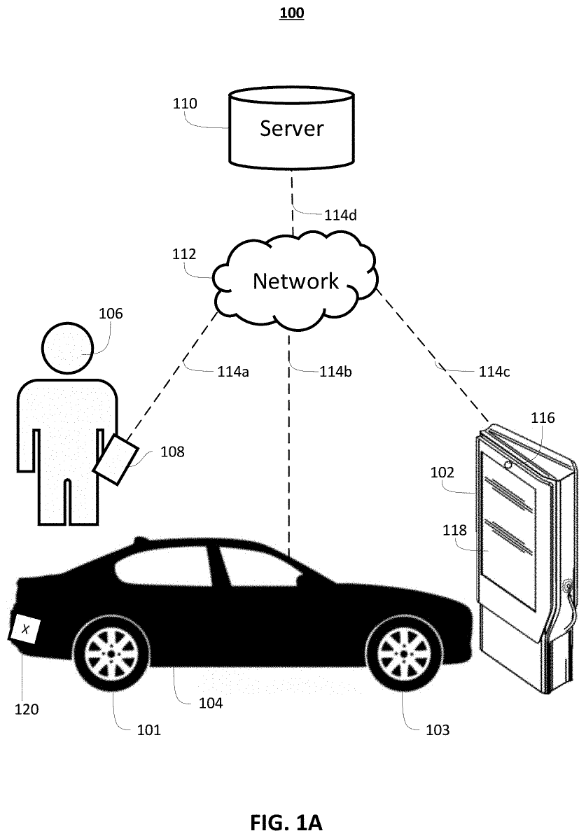

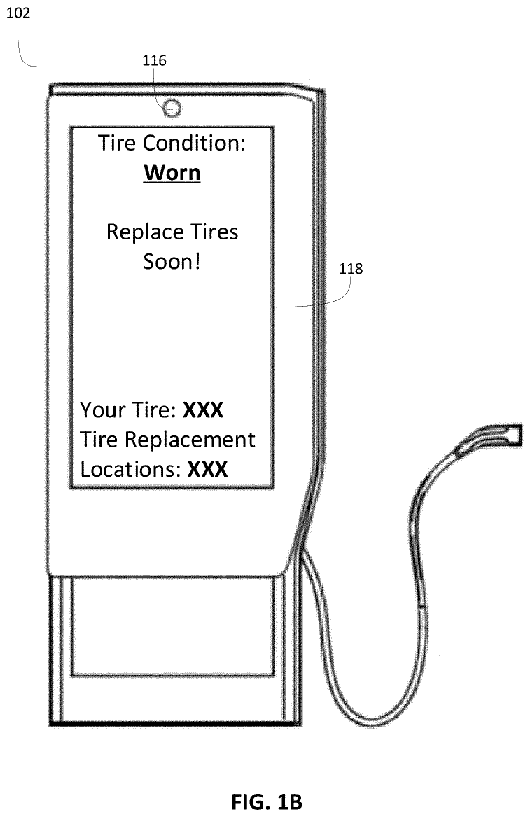

FIG. 1A shows an illustrative diagram of a system 100 for determining a tire characteristic of one or more tires (e.g., back tire 101, front tire 103, etc.) of an electric vehicle 104 and notifying a user 106 of the tire characteristic, in accordance with some embodiments of the disclosure. In some embodiments, the EVCS 102 provides an electric charge to the electric vehicle 104 via a wired connection, such as a charging cable, or a wireless connection (e.g., wireless charging). The EVCS 102 may be in communication with the electric vehicle 104 and/or a user device 108 belonging to a user 106 (e.g., a driver, passenger, owner, renter, or other operator of the electric vehicle 104) that is associated with the electric vehicle 104. In some embodiments, the EVCS 102 communicates with one or more devices or computer systems, such as user device 108 or server 110, respectively, via a network 112.

In the system 100, there can be more than one EVCS 102, electric vehicle 104, user, 106, user device 108, server 110, and network 112, but only one of each is shown in FIG. 1A to avoid overcomplicating the drawing. In addition, a user 106 may utilize more than one type of user device 108 and more than one of each type of user device 108. In some embodiments, there may be paths 114a-d between user devices, EVCSs, electric vehicles, and/or networks, so that the items may communicate directly with each other via communication paths, as well as other short-range point-to-point communication paths, such as USB cables, IEEE 1394 cables, wireless paths (e.g., Bluetooth, infrared, IEEE 802-11x, etc.), or other short-range communication via wired or wireless paths. In some embodiments, the devices may also communicate with each other directly through an indirect path via a communications network. The communications network may be one or more networks including the Internet, a mobile phone network, mobile voice or data network (e.g., a 4G, 5G, or LTE network), cable network, public switched telephone network, or other types of communications network or combinations of communications networks. In some embodiments, a communication network path comprises one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. In some embodiments, a communication network path can be a wireless path. Communications with the devices may be provided by one or more communication paths but is shown as a single path in FIG. 1A to avoid overcomplicating the drawing.

In some embodiments, to determine a tire characteristic of the electric vehicle 104 the EVCS 102 uses one or more sensors (e.g., camera 116) to capture information (e.g., video, photos, etc.) about the electric vehicle 104. For example, these sensors may be image (e.g., optical) sensors (e.g., one or more cameras 116), ultrasound sensors, depth sensors, IR cameras, RGB cameras, PIR cameras, heat IR, proximity sensors, radar, tension sensors, NFC sensors, and/or any combination thereof. In some embodiments, one or more cameras 116 are configured to capture one or more images of an area proximal to the EVCS 102. For example, a camera may be configured to obtain a video or capture images of an area corresponding to a parking spot associated with the EVCS 102, a parking spot next to the parking spot of the EVCS 102, and/or walking paths (e.g., sidewalks) next to the EVCS 102. In some embodiments, the camera 116 may be a wide-angle camera or a 360° camera that is configured to obtain a video or capture images of a large area proximal to the EVCS 102. In some embodiments, the camera 116 may be positioned at locations on the EVCS 102 different from what is shown. In some embodiments, the camera 116 works in conjunction with other sensors. In some embodiments, the one or more sensors (e.g., camera 116) can detect external objects within a region (area) proximal to the EVCS 102. In some embodiments, the one or more sensors are configured to determine a state of the area proximal to the EVCS 102. In some embodiments, the state may correspond to detecting external objects, detecting the lack of external objects, etc. In some embodiments, the external objects may be living or nonliving, such as people, kids, animals, vehicles, shopping carts, toys, etc. In some embodiments, the one or more sensors capture information based on a charging event (e.g., when the EVCS 102 begins charging the electric vehicle 104, when the user 106 checks in, etc.).

In some embodiments, after the one or more sensors capture information about the electric vehicle 104, the EVCS 102 can use this information to determine the electric vehicle's characteristics (e.g., tire characteristics, model, make, license plate, VIN number, specifications, condition, etc.). In some applications, machine learning algorithms can be used to determine the electric vehicle's characteristics using the information captured by the one or more sensors. For example, the EVCS 102 can determine a tire characteristic (e.g., depth of the tire tread of the front tire 103 is two millimeters) using a machine learning algorithm trained using a database comprising a plurality of tire images, wherein the plurality of images indicate the depth of the tire tread of a tire shown in the plurality of images.

In some embodiments, the EVCS 102 uses the determined tire characteristic to determine a tire condition. In some embodiments, the EVCS 102 determines that a tire with a tire tread depth (tire characteristic) over four millimeters is in a “good” condition, a tire with a tire tread depth between four millimeters and two millimeters is in a “worn” condition, and a tire with a tire tread depth below two millimeters is in a “bald” condition. In some embodiments, the EVCS 102 generates different messages based on the tire condition. For example, if the front tire 103 is in a “bald” condition, the EVCS 102 may display a first message reciting “Replace tires as soon as possible.” If the front tire 103 is in a “worn” condition the EVCS 102 may display a second message reciting “Replace your tires soon.” In some embodiments, using the determined tire characteristic (e.g., tire tread depth of two millimeters), the EVCS 102 determines that the front tire 103 is in a “worn condition.” In some embodiments, tire tread conditions are unique to a tire type. For example, a first tire type may be categorized as in “good” condition with less tire tread than a second tire type that would be categorized as in a “worn” condition. In some embodiments, the tire condition categories may be more or less granular than described above. In some embodiments, the tire condition categories may change based on location (e.g., state to state, country to country), time of year, type of vehicle, etc.

In some embodiments, the EVCS 102 notifies the user 106 of the electric vehicle 104 of the determined tire characteristic and/or the determined tire condition. For example, FIG. 1B shows the EVCS 102 displaying the tire condition on the display 118 of the EVCS 102 for the user 106 to see. In some embodiments, by displaying the tire condition on the display 118 of the

EVCS 102, the user 106 of the electric vehicle 104 can quickly and easily discern their vehicle's tire condition. In some embodiments, when the tire condition is “worn,” the EVCS 102 displays a suggestion of “Replace tires soon.” In some embodiments, the suggestion is displayed in conjunction with the notification indicating the condition of the tire.

In some embodiments, the EVCS 102 uses the information captured by the one or more sensors to determine the tire type of one or more tires (e.g., front tire 103, back tire 101, etc.) of the electric vehicle 104. For example, the EVCS 102 can determine the tire type is a 235/45R18 Michelin Primacy MXM4 tire using the information (e.g., size, pattern, texture, shape, etc., of the tire) captured by the one or more sensors. In some embodiments, the EVCS uses a machine learning algorithm to determine the tire type, wherein the machine learning algorithm is trained using a database comprising a plurality of tire images. In some embodiments, each image of the plurality of images displays a tire and indicates the tire type of the displayed tire. In some embodiments, the EVCS 102 receives an image of the sidewall of a tire (e.g., front tire 103, back tire 101, etc.) from the one or more sensors. In some embodiments, the EVCS 102 uses optical character recognition to determine the tire identification number and/or the DOT serial number. In some embodiments, the EVCS 102 uses the tire identification number and/or DOT serial number to determine a tire type of the tire.

In some embodiments, the EVCS 102 includes the determined tire type in the displayed notification in conjunction with the determined tire characteristic and/or the determined tire condition. For example, using the determined tire characteristic (e.g., tire tread depth of two millimeters), the EVCS 102 determines that the front tire 103 is in a “worn” condition. The EVCS 102 also determines that the front tire 103 is a 235/45R18 Michelin Primacy MXM4 tire because one or more images of the front tire 103 show that the front tire 103 has the size, pattern, texture, shape, DOT serial number, and/or tire identification number corresponding to a 235/45R18 Michelin Primacy MXM4 tire. In some embodiments, in response to determining the tire type (e.g., the tire is a 235/45R18 Michelin Primacy MXM4), the EVCS 102 displays a notification on the display 118 indicating the tire condition (e.g., worn) and the tire type (e.g., the tire is a 235/45R18 Michelin Primacy MXM4). In some embodiments, the EVCS 102 also indicates a location that offers the same or similar tire types as the front tire 103 on the electric vehicle 104. In some embodiments, the EVCS 102 determines the location that offers the same or similar tire types by accessing a database linking locations to tire types. In some embodiments, one or more locations are displayed on the display 118 of the EVCS 102. In some embodiments, certain locations are selected for display according to one or more parameters (e.g., distance from EVCS 102, tire prices at the location, user satisfaction related to the location, available appointments, etc.). In some embodiments, locations may pay to be selected for display by the EVCS 102. In some embodiments, the EVCS 102 sends a notification to the user device 108 associated with the user 106 wherein, the notification indicates the same or similar information shown in FIG. 1B.

In some embodiments, the EVCS 102 uses vehicle characteristics (e.g., vehicle model, vehicle make, vehicle condition, etc.) to determine tire characteristics. For example, the EVCS 102 may use images captured by the one or more cameras (e.g., camera 116) to determine the make and model (e.g., 2017 Tesla Model 3) of the electric vehicle 104. In some embodiments, the EVCS 102 accesses a database comprising entries linking vehicle characteristics (e.g., 2017 Tesla Model 3) to tire types (e.g., 235/45R18 Michelin Primacy MXM4). In some embodiments, the EVCS 102 uses the database and the vehicle characteristics (e.g., 2017 Tesla Model 3) to determine the tire type (e.g., 235/45R18 Michelin Primacy MXM4) of the electric vehicle 104.

In another example, the EVCS 102 receives an image of the license plate 120 (e.g., information captured by the one or more sensors) of the electric vehicle 104 from the camera 116. In some embodiments, the EVCS 102 reads the license plate (e.g., using optical character recognition) and uses the license plate information (e.g., electric vehicle characteristic) to determine tire characteristics associated with the electric vehicle 104. In some embodiments, the EVCS 102 uses a database to look up tire characteristics and/or additional vehicle characteristics of the electric vehicle 104 using the license plate information. For example, the database may comprise public records (e.g., public registration information linking license plates to vehicle characteristics and/or tire characteristics), collected information (e.g., entries linking license plates to vehicle characteristics and/or tire characteristics based on data inputted by a user), historical information (entries linking license plates to vehicle characteristics and/or tire characteristics based on the EVCS 102 identifying vehicle characteristics related to one or more license plates in the past), and/or similar such information. In some embodiments, the EVCS 102 determines a tire characteristic (e.g., 235/45R18 Michelin Primacy MXM4) based on the license plate information. In some embodiments, the tire characteristic corresponds to the stock-keeping-unit (SKU) of the tire.

In some embodiments, the EVCS 102 stores vehicle information and/or user information related to the electric vehicle 104 in a profile associated with the electric vehicle 104. In some embodiments, the EVCS 102 stores the profiles in a database that associates a user 106 and/or a user's vehicle 104 with vehicle information and/or user information. In some embodiments, the EVCS 102 uses a profile to more quickly and/or accurately determine tire characteristics for the electric vehicle 104. For example, when the electric vehicle 104 requests charging from the EVCS 102, the EVCS 104 accesses a database comprising a profile associated with the electric vehicle 104. In some embodiments, the EVCS 102 receives tire characteristics (e.g., tire type) from the profile. In some embodiments, the EVCS 102 uses the received tire characteristics (e.g., tire type) to more quickly determine the condition of the front tire 103 because the EVCS 102 does not have to compare the electric vehicle's front tire 103 with different tire types. In some embodiments, the EVCS 102 uses data collected during multiple charging events to determine estimated vehicle information. For example, based on the change in tire tread (e.g., tire tread of the front tire 103 decreased by half a millimeter) between two charging events, the EVCS estimates vehicle information (e.g., the distance the electric vehicle 104 traveled during the time period between the two charging events). In some embodiments, the EVCS 102 uses the estimated vehicle information (e.g., distance traveled) to customize notifications and media items for display by the EVCS 102. In some embodiments, if the EVCS 102 determines, based on the estimated amount of miles traveled by the electric vehicle 104 (estimated vehicle information), that the electric vehicle 104 requires service soon, the EVCS can display a notification recommending that the user 106 schedule a service appointment. In some embodiments, the EVCS 102 also indicates a location that offers servicing of the electric vehicle 104. In some embodiments, the EVCS 102 determines the location offering the servicing by accessing a database linking locations to available services. In some embodiments, one or more locations are displayed on the display 118 of the EVCS 102. In some embodiments, certain locations are selected for display according to one or more parameters (e.g., distance from EVCS 102, service prices at the location, user satisfaction related to the location, available appointments, etc.). In some embodiments, locations may pay to be selected for display by the EVCS 102. In some embodiments, the EVCS 102 sends a notification to the user device 108 associated with the user 106 wherein the notification recommends that the user 106 schedule a service appointment. In some embodiments, the EVCS 102 receives odometer information related to the electric vehicle 104 and uses the odometer information to improve the estimated vehicle information. In some embodiments, the received odometer information is used in conjunction with the information captured by the one or more sensors and/or other vehicle characteristics to train a machine learning algorithm.

In some embodiments, the EVCS 102 uses information captured from the one or more sensors to determine vehicle characteristics of the electric vehicle 104 and/or to determine the user 106 associated with the electric vehicle 104. In some embodiments, upon connection, the EVCS 102 receives a media access control (MAC) address from the electric vehicle 104, and the EVCS 102 uses the MAC address to determine vehicle characteristics (e.g., tire type) of the electric vehicle 104 and/or to determine the user 106 associated with the electric vehicle 104. In some embodiments, the EVCS 102 uses a database to match the received MAC address or portions of the received MAC address to entries in the database to determine vehicle characteristics (e.g., tire type) of the electric vehicle 104. For example, certain vehicle manufacturers keep portions of their produced electric vehicle's MAC addresses consistent.

Accordingly, if the EVCS 102 determines that a portion of the MAC address received from the electric vehicle 104 corresponds to an electric vehicle manufacturer, the EVCS 102 can determine vehicle characteristics of the electric vehicle 104. In some embodiments, the EVCS 102 also uses the database to match the received MAC address or portions of the received MAC address to entries in the database to identify a profile. In some embodiments, the profile is associated with the user 106 and/or the electric vehicle 104.

In some embodiments, the EVCS 102 uses user information to determine vehicle characteristics of the electric vehicle 104. For example, the user 106 may input vehicle characteristics (e.g., make and model) into a profile that is accessible by the EVCS 102. In some embodiments, when the EVCS 102 determines that the user 106 is charging their electric vehicle 104, the EVCS 102 receives vehicle characteristics associated with the electric vehicle 104 from a profile associated with the user 106. In some embodiments, the EVCS 102 uses user information to more quickly and/or accurately determine tire characteristics for the electric vehicle 104. For example, once the EVCS 102 identifies the user 106, the EVCS 102 can retrieve recorded vehicle information (e.g., tire characteristics) associated with the electric vehicle 104 of the user. In some embodiments, the EVCS 102 uses the received tire characteristics (e.g., tire type) to more quickly determine the condition of the front tire 103 because the EVCS 102 does not have to compare the electric vehicle's front tire 103 with different tire types.

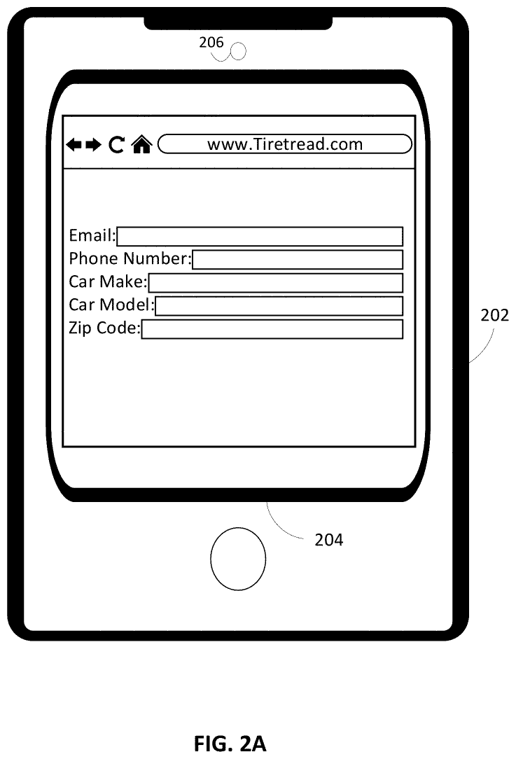

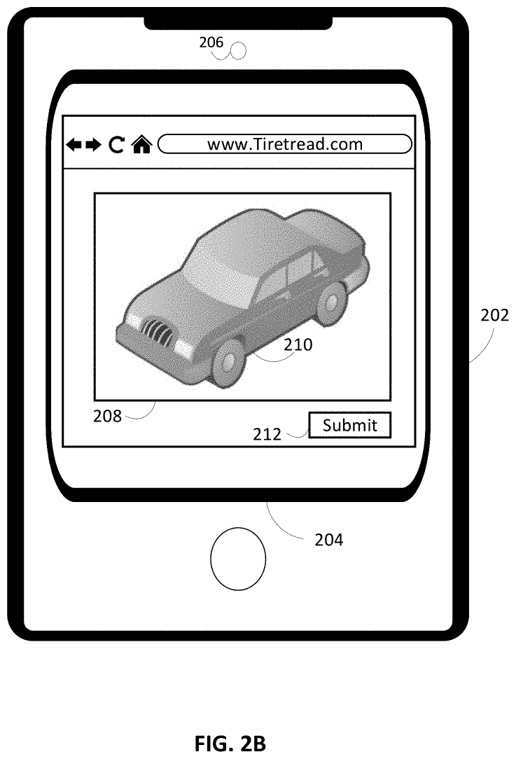

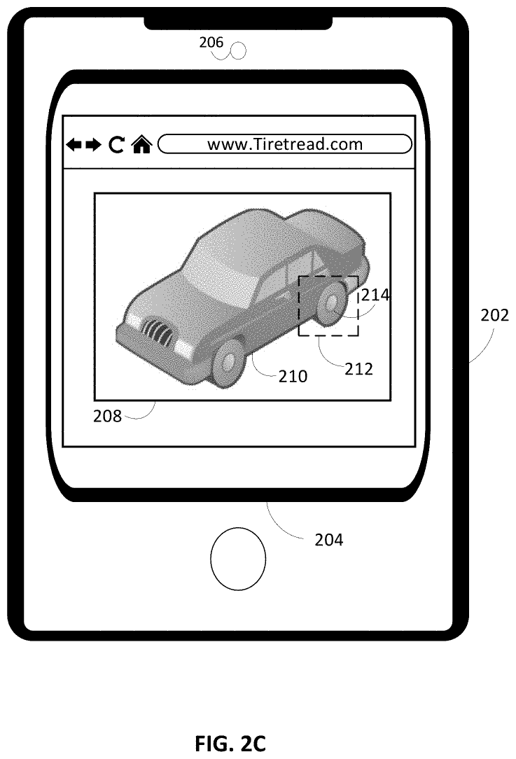

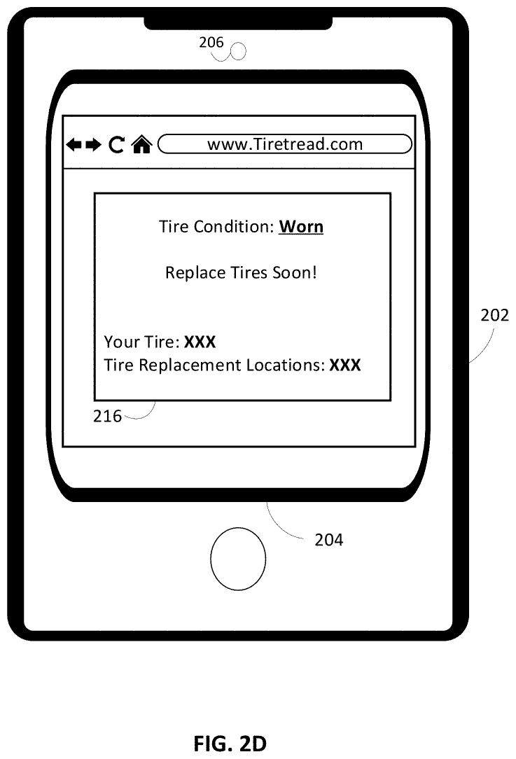

FIGS. 2A-2D show illustrative diagrams for determining a tire characteristic of an electric vehicle's tire and notifying a user of the tire characteristic, in accordance with some embodiments of the disclosure. In some embodiments, FIGS. 2A-2D use the same or similar methods and devices described in FIGS. 1A and 1B. FIGS. 2A-2D show a user device 202 comprising a display 204 and a camera 206. In some embodiments, the user device 202 is the same as the user device 108 depicted in FIG. 1A. In some embodiments, user device 202 comprises an additional camera on the back side of the user device 202. In some embodiments, user device 202 can communicate with an EVCS (e.g., EVCS 102), an electric vehicle (e.g., electric vehicle 104), a server (e.g., server 110), other user device, and/or similar such devices using the communication network described above in relation to FIGS. 1A and 1B.

FIG. 2A shows a user device 202 presenting an illustrative login screen on display 204. In some embodiments, a user navigates to an application, website, and/or similar such location to determine a tire characteristic of their vehicle. In some embodiments, the user inputs information (email, phone number, vehicle make, vehicle model, zip code, etc.) related to the user and/or the vehicle. In some embodiments, the user only inputs the information once, and it is saved to a profile related to the user and/or the vehicle. In some embodiments, the user inputs credentials (e.g., password, pin, biometrics, device, item, etc.) to access a profile associated with the user and/or the vehicle. In some embodiments, inputted information is used to generate customer leads and/or to customize media items for display.

FIG. 2B shows a user device 202 displaying an image 208 of a vehicle 210. In some embodiments, the image 208 represents an image captured by the camera 206 of the device 202. In some embodiments, the image 208 was taken previously and stored on the device 202. In some embodiments, the user of the device 202 may submit the image 208 for processing using the submit button 212. In some embodiments, the image 208 is processed on the user device 202. In some embodiments, the image 208 is sent to a server for processing.

FIG. 2C shows a user device 202 displaying an image 208 of a vehicle 210. In some embodiments, the device 202 displays a bounding box 212 around the tire 214 that is being analyzed for tire characteristics. In some embodiments, the analyzing is done on the user device 202. In some embodiments, the analyzing is done on a server. In some embodiments, the image 208 is a frame of a video. For example, the device 208 may be capturing images in real time and the one or more frames (e.g., 208) are analyzed for tire characteristics. In some embodiments, a tire characteristic (e.g., depth of the tire tread) of the tire 214 is determined using a machine learning algorithm trained using a database comprising a plurality of tire images wherein the plurality of images indicate the depth of the tire tread of a tire shown in the plurality of images. In some embodiments, the image 208 is compared to a plurality of images to determine a tire characteristic of the tire 214. In some embodiments, the determining of the tire characteristic is facilitated by the information inputted in FIG. 2A. In some embodiments, if information (e.g., the make and model of the vehicle 210) is inputted, the information is used to estimate a tire characteristic. In some embodiments, the inputted information (e.g., the make and model of the vehicle 210) corresponds to a certain tire type. In some embodiments, when the tire type is determined, the image 208 is compared to a plurality of images that display the same type as the determined tire type. This results in increasing the accuracy and speed of the determination of tire characteristics (e.g., tire tread depth).

FIG. 2D shows a user device 202 displaying a notification 216 on the display 204. In some embodiments, the notification 216 comprises the determined tire characteristic and/or the determined tire condition. As shown, the user device 202 displays that the tire condition is “worn.” In some embodiments, the user device 202 also displays a tire characteristic (e.g., depth of the tire tread). In some embodiments, the displayed tire condition is the condition of tire 214 shown in FIG. 2C. In some embodiments, using the tire characteristic (e.g., tire tread depth of two millimeters) determined from the image 208, the user device 202 and/or server determines that the tire 214 is in a “worn” condition.

In some embodiments, the estimated tire characteristic is used to customize media items to display to the users of the electric vehicles. In some embodiments, when the tire condition is “worn,” the user device 202 also displays a suggestion (e.g., “Replace tires soon!”). In some embodiments, the notification 216 or parts of the notification are generated by the user device 202 and/or server. In some embodiments, by displaying the tire condition on the display 204 of the user device 202, the user of the user device 202 can quickly and easily discern the tire condition of the vehicle 210. In some embodiments, the notification 216 also includes the tire type of the tire 214. In some embodiments, the tire type (e.g., 235/45R18 Michelin Primacy MXM4) of the tire 214 is determined because one or more images (e.g., image 208) of the tire 214 show that the tire 214 has the size, pattern, texture, shape, DOT serial number, and/or tire identification number corresponding to a certain tire type. In some embodiments, the information (e.g., the make and model of the vehicle 210) inputted by the user in FIG. 2A is used to estimate a tire characteristic. For example, the inputted information (e.g., the make and model of the vehicle 210) corresponds to a certain tire type. In some embodiments, in response to determining the tire type (e.g., the tire is a 235/45R18 Michelin Primacy MXM4), the notification 216 displays the tire type (e.g., the tire is a 235/45R18 Michelin Primacy MXM4) with the tire condition (e.g., worn). In some embodiments, the notification 216 also indicates a location that offers the same or similar tire types as the tire 214 of the vehicle 210. In some embodiments, the user device 202 and/or server determines one or more locations that offer the same or similar tire types by accessing a database linking locations to tire types. In some embodiments, certain locations are included in the notification 216 according to one or more parameters (e.g., distance from the user device 202, tire prices at the location, user satisfaction related to the location, available appointments, etc.). In some embodiments, locations may pay to be included in the notification 216. In some embodiments, the information inputted in FIG. 2A is transmitted with the determined vehicle characteristic to locations that offer vehicle repair to generate customer leads.

In some embodiments, the image 208 and the determined tire characteristics are used to train a machine learning algorithm. In some embodiments, a user can submit measured tire characteristics (e.g., tire tread depth, tire condition) along with the image 208. In some embodiments, the measured tire characteristic and image 208 are used to train a machine learning algorithm. In some embodiments, the notification 216 is incorrect (e.g., indicating that brand new tires are “worn”). In some embodiments, the user can submit a new image when the notification 216 is incorrect.

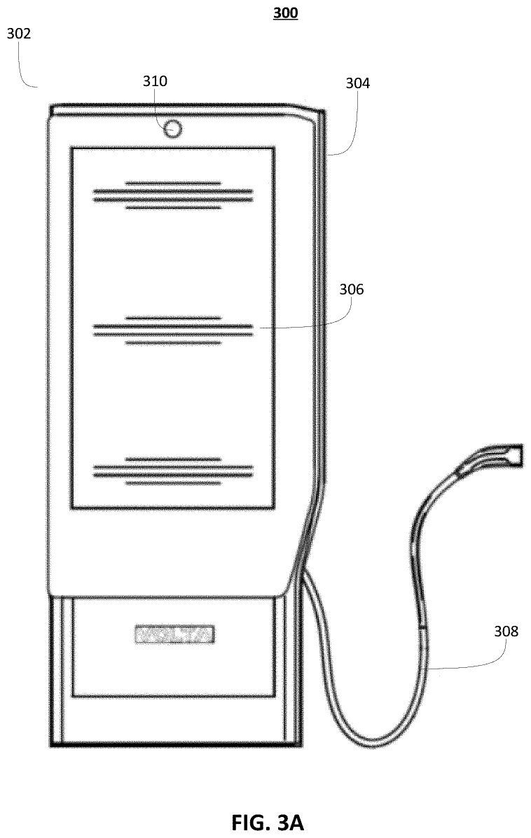

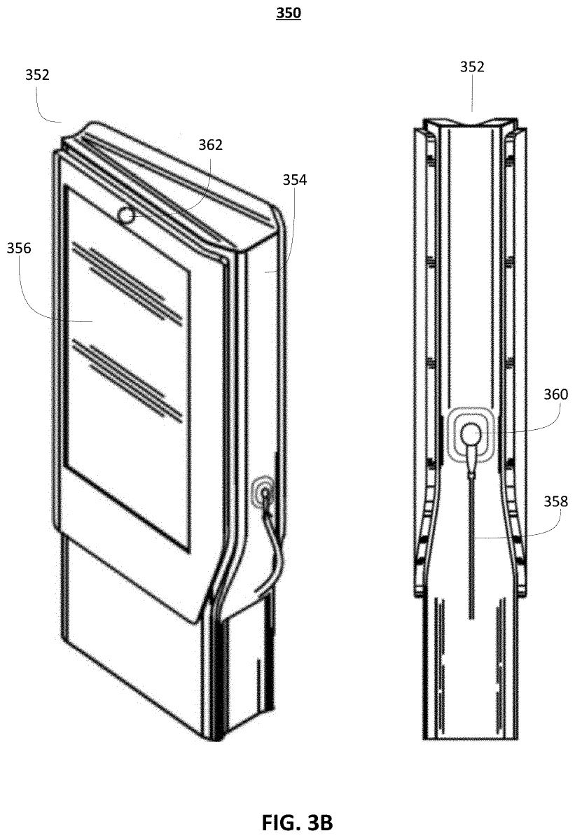

FIG. 3A illustrates an EVCS used for determining a tire characteristic of an electric vehicle's tire and notifying a user of the tire characteristic, in accordance with some embodiments of the disclosure. In some embodiments, FIG. 3A illustrates the EVCS displayed in FIGS. 1A and 1B. EVCS 302 includes a housing 304 (e.g., a body or a chassis) that holds a display 306. In some embodiments, EVCS 302 comprises more than one display. For example, EVCS 302 may have a first display 306 and a second display (on the other side of EVCS 302). In some embodiments, the display 306 is large compared to the housing 304 (e.g., 60% or more of the height of the frame and 80% or more of the width of the frame), allowing the display 306 to function as a billboard, capable of conveying information to passersby. In some embodiments, the one or more displays 306 display messages (e.g., media items) to users of the EVCS 302 (e.g., operators of the electric vehicle) and/or to passersby that are in proximity to the EVCS 302. In some embodiments, the display 306 has a height that is at least three feet and a width that is at least two feet.

EVCS 302 further comprises a computer that includes one or more processors and memory. In some embodiments, the memory stores instructions for displaying content on the display 306. In some embodiments, the computer is disposed inside the housing 304. In some embodiments, the computer is mounted on a panel that connects (e.g., mounts) a first display (e.g., a display 306) to the housing 304. In some embodiments, the computer includes a near-field communication (NFC) system that is configured to interact with a user's device (e.g., user device 108 of a user 106 in FIG. 1A).

EVCS 302 further comprises a charging cable 308 (e.g., connector) configured to connect and provide a charge to an electric vehicle (e.g., electric vehicle 104 of FIG. 1A). In some embodiments, the charging cable 308 is an IEC 62196 type-2 connector. In some embodiments, the charging cable 308 is a “gun-type” connector (e.g., a charge gun) that, when not in use, sits in a holder (e.g., a holster). In some embodiments, the housing 304 houses circuitry for charging an electric vehicle. For example, in some embodiments, the housing 304 includes power supply circuitry as well as circuitry for determining a state of a vehicle being charged (e.g., whether the vehicle is connected via the connector, whether the vehicle is charging, whether the vehicle is done charging, etc.). In some embodiments, EVCS 302 supports ISO 15118, which allows a user to plug their electric vehicle into EVCS 302 and begin charging without inputting any additional information. ISO 15118 is a communication interface, which, among other things, can identify the make and model of an electric vehicle to an EVCS. When an electric vehicle that supports ISO 15118 begins charging, EVCS 302 can receive vehicle characteristics (e.g., make and model of the electric vehicle) using ISO 15118.

EVCS 302 further comprises one or more cameras 310 configured to capture one or more images of an area proximal to EVCS 302. In some embodiments, the one or more cameras 310 are configured to obtain video of an area proximal to the EVCS 302. For example, a camera may be configured to obtain a video or capture images of an area corresponding to a parking spot associated with EVCS 302. In another example, another camera may be configured to obtain a video or capture images of an area corresponding to a parking spot next to the parking spot of EVCS 302. In some embodiments, the camera 310 may be a wide-angle camera or a 360° camera that is configured to obtain a video or capture images of a large area proximal to EVCS 302. The one or more cameras 310 may be mounted directly on the housing 304 of EVCS 302 and may have a physical (e.g., electrical, wired) connection to EVCS 302 or a computer system associated with EVCS 302. In some embodiments, the one or more cameras 310 (or other sensors) may be disposed separately from but proximal to the housing 304 of EVCS 302. In some embodiments, the camera 310 may be positioned at locations on EVCS 302 different from what is shown. In some embodiments, the one or more cameras 310 include a plurality of cameras positioned at different locations on EVCS 302.

In some embodiments, EVCS 302 further comprises one or more sensors (not shown). In some embodiments, the one or more sensors detect external objects within a region (area) proximal to EVCS 302. In some embodiments, the area proximal to EVCS 302 includes one or more parking spaces, where an electric vehicle parks in order to use EVCS 302. In some embodiments, the area proximal to EVCS 302 includes walking paths (e.g., sidewalks) next to EVCS 302. In some embodiments, the one or more sensors are configured to determine a state of the area proximal to EVCS 302 (e.g., wherein determining the state includes detecting external objects or the lack thereof). In some embodiments, the external objects can be living or nonliving, such as people, kids, animals, vehicles, shopping carts, toys, etc. In some embodiments, the one or more sensors can detect stationary or moving external objects. In some embodiments, the one or more sensors may be one or more image (e.g., optical) sensors (e.g., one or more cameras 310), ultrasound sensors, depth sensors, Infrared (IR) cameras, Red Green Blue (RGB) cameras, Passive IP (PIR) cameras, heat IR, proximity sensors, radar, tension sensors, near field communication (NFC) sensors, and/or any combination thereof. The one or more sensors may be connected to EVCS 302 or a computer system associated with EVCS 302 via wired or wireless connections such as via a Wi-Fi connection or Bluetooth connection.

In some embodiments, EVCS 302 further comprises one or more lights configured to provide predetermined illumination patterns indicating a status of EVCS 302. In some embodiments, at least one of the one or more lights is configured to illuminate an area proximal to EVCS 302 as a person approaches the area (e.g., a driver returning to a vehicle or a passenger exiting a vehicle that is parked in a parking spot associated with EVCS 302).

FIG. 3B illustrates an EVCS 352 used for determining a tire characteristic of an electric vehicle's tire and notifying a user of the tire characteristic, in accordance with some embodiments of the disclosure. In some embodiments, FIG. 3B illustrates the EVCSs displayed in FIGS. 1A, 1B, and 3A. In some embodiments, FIG. 3B displays additional views of EVCS 302 shown in FIG. 3A. In some embodiments, EVCS 352 comprises housing 354, one or more displays 356, charging cable 358, charging cable holder 360, and one or more cameras 362.

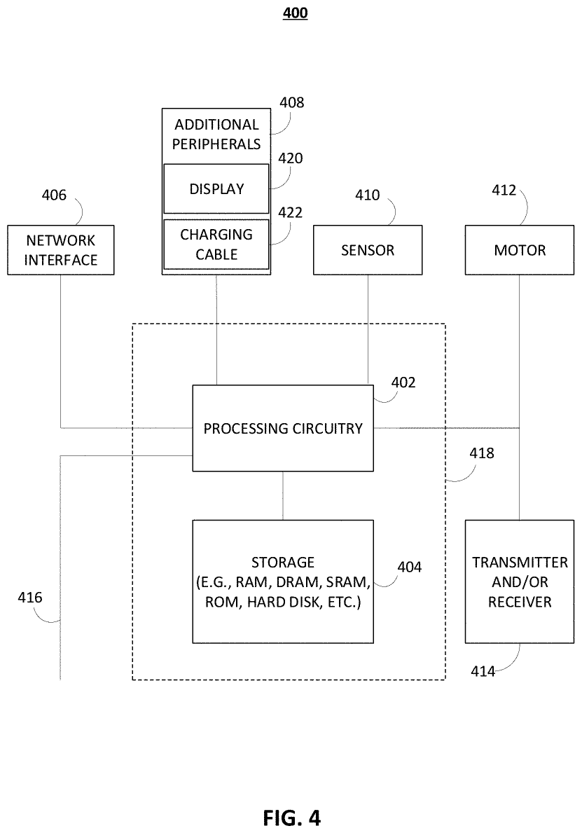

FIG. 4 shows an illustrative block diagram of an EVCS system 400, in accordance with some embodiments of the disclosure. In particular, EVCS system 400 of FIG. 4 may be any of the EVCSs depicted in FIGS. 1A, 1B, 3A, and/or 3B. In practice, and as recognized by those of ordinary skill in the art, items shown separately could be combined and some items could be separated. In some embodiments, not all shown items must be included in EVCS 400. In some embodiments, EVCS 400 may comprise additional items.

The EVCS system 400 can include processing circuitry 402, which includes one or more processing units (processors or cores), storage 404, one or more networks or other communications network interfaces 406, additional peripherals 408, one or more sensors 410, a motor 412 (configured to retract a portion of a charging cable), one or more wireless transmitters and/or receivers 414, and one or more input/output (I/O) paths 416. I/O paths 416 may use communication buses for interconnecting the described components. I/O paths 416 can include circuitry (sometimes called a chipset) that interconnects and controls communications between system components. EVCS 400 may receive content and data via I/O paths 416. The I/O path 416 may provide data to control circuitry 418, which includes processing circuitry 402 and a storage 404. The control circuitry 418 may be used to send and receive commands, requests, and other suitable data using the I/O path 416. The I/O path 416 may connect the control circuitry 418 (and specifically the processing circuitry 402) to one or more communications paths. I/O functions may be provided by one or more of these communications paths but are shown as a single path in FIG. 4 to avoid overcomplicating the drawing.

The control circuitry 418 may be based on any suitable processing circuitry such as the processing circuitry 402. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). The determining a tire characteristic of an electric vehicle's tires and notifying a user of the tire characteristic functionality can be at least partially implemented using the control circuitry 418. The determining a tire characteristic of an electric vehicle's tires and notifying a user of the tire characteristic functionality described herein may be implemented in or supported by any suitable software, hardware, or combination thereof. The determining a tire characteristic of an electric vehicle's tires and notifying a user of the tire characteristic functionality can be implemented on user equipment, on remote servers, or across both.

The control circuitry 418 may include communications circuitry suitable for communicating with one or more servers. The instructions for carrying out the above-mentioned functionality may be stored on the one or more servers. Communications circuitry may include a cable modem, an integrated service digital network (ISDN) modem, a digital subscriber line (DSL) modem, a telephone modem, an Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as the storage 404 that is part of the control circuitry 418. As referred to herein, the phrase “storage device” or “memory device” should be understood to mean any device for storing electronic data, computer software, or firmware, such as random-access memory, read-only memory, high-speed random-access memory (e.g., DRAM, SRAM, DDR RAM, or other random-access solid-state memory devices), non-volatile memory, one or more magnetic disk storage devices, optical disk storage devices, flash memory devices, other non-volatile solid-state storage devices, quantum storage devices, and/or any combination of the same. In some embodiments, the storage 404 includes one or more storage devices remotely located, such as a database of a server system that is in communication with EVCS 400. In some embodiments, the storage 404, or alternatively the non-volatile memory devices within the storage 404, includes a non-transitory computer-readable storage medium.

In some embodiments, storage 404 or the computer-readable storage medium of the storage 404 stores an operating system, which includes procedures for handling various basic system services and for performing hardware-dependent tasks. In some embodiments, storage 404 or the computer-readable storage medium of the storage 404 stores a communications module, which is used for connecting EVCS 400 to other computers and devices via the one or more communication network interfaces 406 (wired or wireless), such as the Internet, other wide area networks, local area networks, metropolitan area networks, and so on. In some embodiments, storage 404 or the computer-readable storage medium of the storage 404 stores a media item module for selecting and/or displaying media items on the display(s) 420 to be viewed by passersby and users of EVCS 400. In some embodiments, storage 404 or the computer-readable storage medium of the storage 404 stores an EVCS module for charging an electric vehicle (e.g., measuring how much charge has been delivered to an electric vehicle, commencing charging, ceasing charging, etc.), including a motor control module that includes one or more instructions for energizing or forgoing energizing the motor. In some embodiments, storage 404 or a computer-readable storage medium of the storage 404 stores an EVCS module for determining a tire characteristic of an electric vehicle's tires and/or notifying a user of the tire characteristic. In some embodiments, executable modules, applications, or sets of procedures may be stored in one or more of the previously mentioned memory devices and correspond to a set of instructions for performing a function described above. In some embodiments, modules or programs (i.e., sets of instructions) need not be implemented as separate software programs, procedures, or modules, and thus various subsets of modules may be combined or otherwise re-arranged in various implementations. In some embodiments, the storage 404 stores a subset of the modules and data structures identified above. In some embodiments, the storage 404 may store additional modules or data structures not described above.

In some embodiments, EVCS 400 comprises additional peripherals 408 such as displays 420 for displaying content and charging cable 422. In some embodiments, the displays 420 may be touch-sensitive displays that are configured to detect various swipe gestures (e.g., continuous gestures in vertical and/or horizontal directions) and/or other gestures (e.g., a single or double tap) or to detect user input via a soft keyboard that is displayed when keyboard entry is needed.

In some embodiments, EVCS 400 comprises one or more sensors 410 such as cameras (e.g., camera, described above with respect to FIGS. 1A, 3A and/or 3B), ultrasound sensors, depth sensors, IR cameras, RGB cameras, PIR cameras, heat IR, proximity sensors, radar, tension sensors, NFC sensors, and/or any combination thereof. In some embodiments, the one or more sensors 410 are for detecting whether external objects are within a region proximal to EVCS 400, such as living and nonliving objects, and/or the status of EVCS 400 (e.g., available, occupied, etc.) in order to perform an operation, such as determining a tire characteristic, a vehicle characteristic, user information, region status, etc.

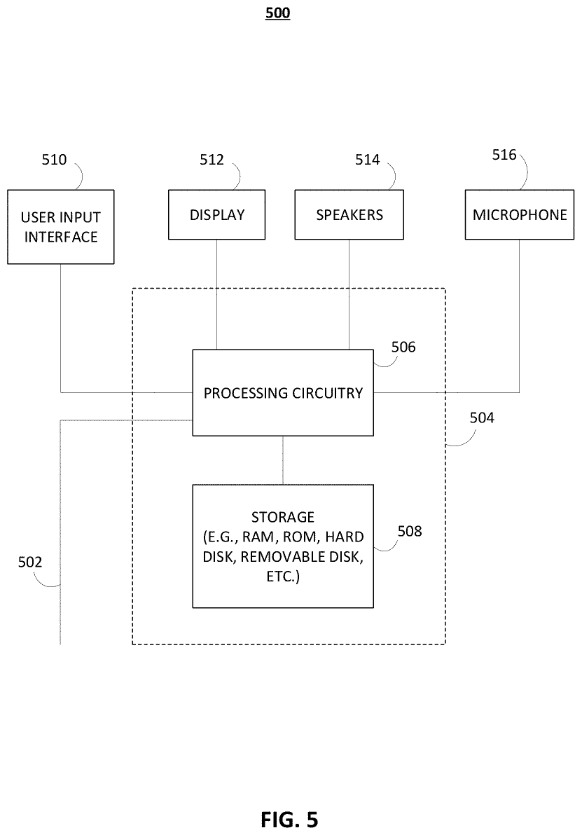

FIG. 5 shows an illustrative block diagram of a user equipment device system, in accordance with some embodiments of the disclosure. In practice, and as recognized by those of ordinary skill in the art, items shown separately could be combined and some items could be separated. In some embodiments, not all shown items must be included in device 500. In some embodiments, device 500 may comprise additional items. In an embodiment, the user equipment device 500 is the same user equipment device displayed in FIGS. 1A and/or 2A-D. The user equipment device 500 may receive content and data via input/output I/O path 502. The I/O path 502 may provide audio content (e.g., broadcast programming, on-demand programming, Internet content, content available over a local area network (LAN) or wide area network (WAN), and/or other content) and data to control circuitry 504, which includes processing circuitry 506 and a storage 508. The control circuitry 504 may be used to send and receive commands, requests, and other suitable data using the I/O path 502. The I/O path 502 may connect the control circuitry 504 (and specifically the processing circuitry 506) to one or more communications paths. I/O functions may be provided by one or more of these communications paths but are shown as a single path in FIG. 5 to avoid overcomplicating the drawing.

The control circuitry 504 may be based on any suitable processing circuitry such as the processing circuitry 506. As referred to herein, processing circuitry should be understood to mean circuitry based on one or more microprocessors, microcontrollers, digital signal processors, programmable logic devices, FPGAs, ASICs, etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

In client/server-based embodiments, the control circuitry 504 may include communications circuitry suitable for communicating with one or more servers that may at least implement the described allocation of services functionality. The instructions for carrying out the above-mentioned functionality may be stored on the one or more servers. Communications circuitry may include a cable modem, an ISDN modem, a DSL modem, a telephone modem, an Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as the storage 508 that is part of the control circuitry 504. Storage 508 may include random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVRs, sometimes called a personal video recorder, or PVRs), solid-state devices, quantum storage devices, gaming consoles, gaming media, or any other suitable fixed or removable storage devices, and/or any combination of the same. The storage 508 may be used to store various types of content described herein. Nonvolatile memory may also be used (e.g., to launch a boot-up routine and other instructions). Cloud-based storage may be used to supplement the storage 508 or instead of the storage 508.

The control circuitry 504 may include audio-generating circuitry and tuning circuitry, such as one or more analog tuners, audio generation circuitry, filters or any other suitable tuning or audio circuits or combinations of such circuits. The control circuitry 504 may also include scaler circuitry for upconverting and down converting content into the preferred output format of the user equipment device 500. The control circuitry 504 may also include digital-to-analog converter circuitry and analog-to-digital converter circuitry for converting between digital and analog signals. The tuning and encoding circuitry may be used by the user equipment device 500 to receive and to display, to play, or to record content. The circuitry described herein, including, for example, the tuning, audio-generating, encoding, decoding, encrypting, decrypting, scaler, and analog/digital circuitry, may be implemented using software running on one or more general purpose or specialized processors. If the storage 508 is provided as a separate device from the user equipment device 500, the tuning and encoding circuitry (including multiple tuners) may be associated with the storage 508.

The user may utter instructions to the control circuitry 504 that are received by the microphone 516. The microphone 516 may be any microphone (or microphones) capable of detecting human speech. The microphone 516 is connected to the processing circuitry 506 to transmit detected voice commands and other speech thereto for processing. In some embodiments, voice assistants (e.g., Siri, Alexa, Google Home, and similar such voice assistants) receive and process the voice commands and other speech.

The user equipment device 500 may optionally include an interface 510. The interface 510 may be any suitable user interface, such as a remote control, mouse, trackball, keypad, keyboard, touch screen, touchpad, stylus input, joystick, or other user input interfaces. A display 512 may be provided as a stand-alone device or integrated with other elements of the user equipment device 500. For example, the display 512 may be a touchscreen or touch-sensitive display. In such circumstances, the interface 510 may be integrated with or combined with the microphone 516. When the interface 510 is configured with a screen, such a screen may be one or more of a monitor, television, liquid crystal display (LCD) for a mobile device, active matrix display, cathode ray tube display, light-emitting diode display, organic light-emitting diode display, quantum dot display, or any other suitable equipment for displaying visual images. In some embodiments, the interface 510 may be HDTV-capable. In some embodiments, the display 512 may be a 3D display. The speaker (or speakers) 514 may be provided as integrated with other elements of user equipment device 500 or may be a stand-alone unit. In some embodiments, the display 512 may be outputted through speaker 514.

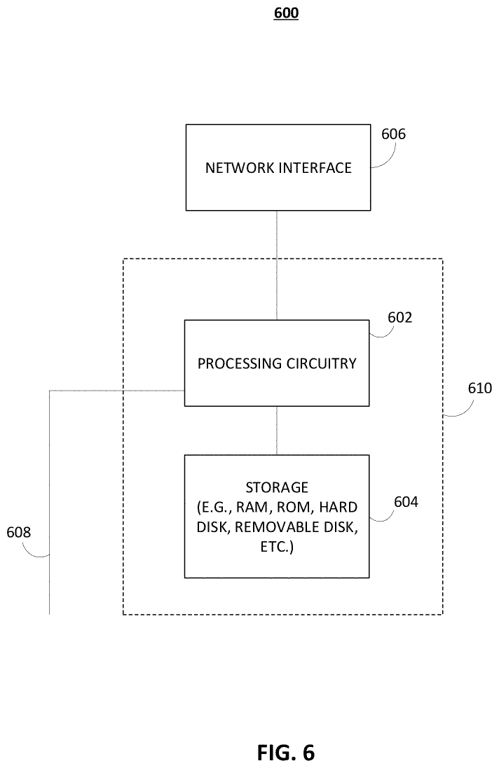

FIG. 6 shows an illustrative block diagram of a server system 600, in accordance with some embodiments of the disclosure. Server system 600 may include one or more computer systems (e.g., computing devices), such as a desktop computer, a laptop computer, and a tablet computer. In some embodiments, the server system 600 is a data server that hosts one or more databases (e.g., databases of images or videos), models, or modules or may provide various executable applications or modules. In practice, and as recognized by those of ordinary skill in the art, items shown separately could be combined and some items could be separated. In some embodiments, not all shown items must be included in server system 600. In some embodiments, server system 600 may comprise additional items.

The server system 600 can include processing circuitry 602 that includes one or more processing units (processors or cores), storage 604, one or more networks or other communications network interfaces 606, and one or more I/O paths 608. I/O paths 608 may use communication buses for interconnecting the described components. I/O paths 608 can include circuitry (sometimes called a chipset) that interconnects and controls communications between system components. Server system 600 may receive content and data via I/O paths 608. The I/O path 608 may provide data to control circuitry 610, which includes processing circuitry 602 and a storage 604. The control circuitry 610 may be used to send and receive commands, requests, and other suitable data using the I/O path 608. The I/O path 608 may connect the control circuitry 610 (and specifically the processing circuitry 602) to one or more communications paths. I/O functions may be provided by one or more of these communications paths but are shown as a single path in FIG. 6 to avoid overcomplicating the drawing.

The control circuitry 610 may be based on any suitable processing circuitry such as the processing circuitry 602. As referred to herein, processing circuitry should be understood to mean circuitry based on one or more microprocessors, microcontrollers, digital signal processors, programmable logic devices, FPGAs, ASICs, etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

Memory may be an electronic storage device provided as the storage 604 that is part of the control circuitry 610. Storage 604 may include random-access memory, read-only memory, high-speed random-access memory (e.g., DRAM, SRAM, DDR RAM, or other random-access solid-state memory devices), non-volatile memory, one or more magnetic disk storage devices, optical disk storage devices, flash memory devices, other non-volatile solid-state storage devices, quantum storage devices, and/or any combination of the same.

In some embodiments, storage 604 or the computer-readable storage medium of the storage 604 stores an operating system, which includes procedures for handling various basic system services and for performing hardware-dependent tasks. In some embodiments, storage 604 or the computer-readable storage medium of the storage 604 stores a communications module, which is used for connecting the server system 600 to other computers and devices via the one or more communication network interfaces 606 (wired or wireless), such as the Internet, other wide area networks, local area networks, metropolitan area networks, and so on. In some embodiments, storage 604 or the computer-readable storage medium of the storage 604 stores a web browser (or other application capable of displaying web pages), which enables a user to communicate over a network with remote computers or devices. In some embodiments, storage 604 or the computer-readable storage medium of the storage 604 stores a database for storing information on electric vehicle charging stations, their locations, media items displayed at respective electric vehicle charging stations, a number of each type of impression count associated with respective electric vehicle charging stations, user profiles, vehicle information, and so forth.

In some embodiments, executable modules, applications, or sets of procedures may be stored in one or more of the previously mentioned memory devices and correspond to a set of instructions for performing a function described above. In some embodiments, modules or programs (i.e., sets of instructions) need not be implemented as separate software programs, procedures, or modules, and thus various subsets of modules may be combined or otherwise re-arranged in various implementations. In some embodiments, the storage 604 stores a subset of the modules and data structures identified above. In some embodiments, the storage 604 may store additional modules or data structures not described above.

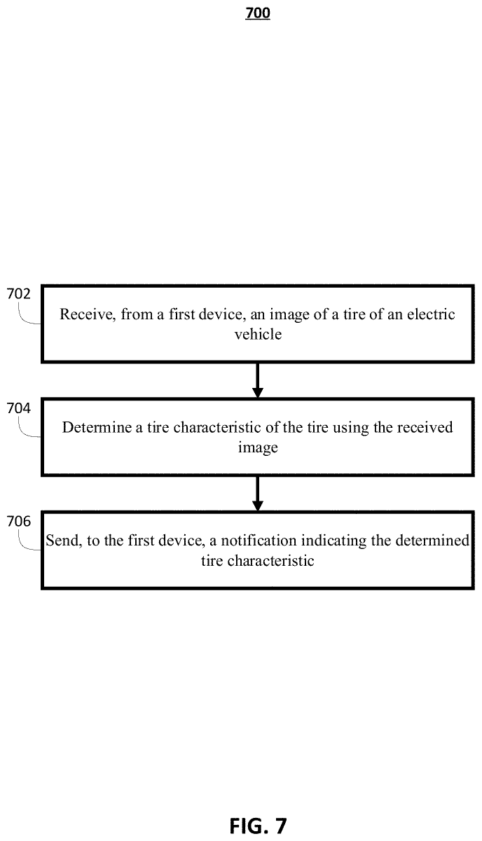

FIG. 7 is an illustrative flowchart of a process 700 for determining a tire characteristic of an electric vehicle's tire and notifying a user of the tire characteristic, in accordance with some embodiments of the disclosure. Process 700 may be performed by physical or virtual control circuitry, such as control circuitry 418 of EVCS (FIG. 4), control circuitry 504 of user device (FIG. 5), and/or control circuitry 610 of server (FIG. 6). In some embodiments, some steps of process 700 may be performed by one of several devices. In some embodiments, the vehicle need not be an electric vehicle.

At step 702, control circuitry receives from a first device an image of a tire of an electric vehicle. In some embodiments, the first device is an EVCS (e.g., EVCS 400), user device (e.g., user device 500), and or similar such device. In some embodiments, the image of the tire is captured using one or more sensors. For example, these sensors may be image (e.g., optical) sensors (e.g., one or more cameras 116), ultrasound sensors, depth sensors, IR cameras, RGB cameras, PIR cameras, heat IR, proximity sensors, radar, tension sensors, NFC sensors, and/or any combination thereof. In some embodiments, the image of the tire of the electric vehicle is transmitted due to an event (e.g., a device determining that a vehicle is within a vicinity of the device, a user requesting tire characteristic information, an electric vehicle requesting charging, etc.).

At step 704, control circuitry determines a tire characteristic of the tire using the received image. In some embodiments, a machine learning algorithm is used to determine the tire characteristic (e.g., depth of the tire tread) using the received image. In some embodiments, the machine learning algorithm is trained using a database comprising a plurality of tire images wherein the images indicate the depth and/or condition of the tire treads of the tires shown in the plurality of images.

In some embodiments, the control circuitry uses the determined tire characteristic to determine a tire condition. In some embodiments, the control circuitry determines that a tire with a tire tread depth (tire characteristic) over six millimeters is in a “good” condition, a tire with a tire tread depth between six millimeters and three millimeters is in an “ok” condition, and a tire with a tire tread depth below three millimeters is in a “worn” condition and should be replaced soon. In some embodiments, using the determined tire characteristic (e.g., tire tread depth of two millimeters), the control circuitry determines that the tire in the received image is in a “worn” condition.

At step 706, control circuitry sends to the first device a notification indicating the determined tire characteristic. In some embodiments, the notification is the notification shown in FIG. 1B or FIG. 2D. In some embodiments, the notification comprises one or more tire characteristics, tire conditions, suggestions, media items, etc. In some embodiments, the notification allows a user to quickly and easily discern their vehicle's tire condition. In some embodiments, the notification comprises information determined using the received image. For example, the control circuitry determines the tire type (e.g., 235/45R18 Michelin Primacy MXM4) of the tire in the received image using the size, pattern, texture, shape, DOT serial number, and/or tire identification number displayed in the received image. In some embodiments, the control circuitry uses information inputted by the user in conjunction with image information to generate the notification.

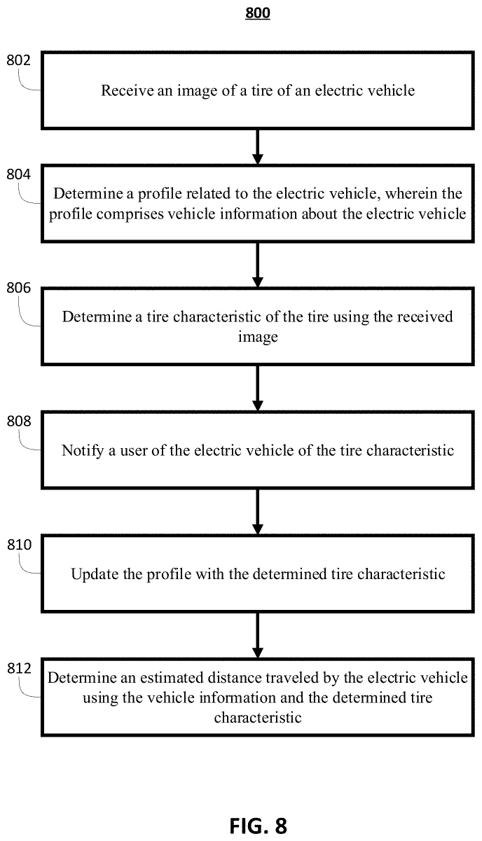

FIG. 8 is another illustrative flowchart of a process 800 for determining a tire characteristic of an electric vehicle's tire and notifying a user of the tire characteristic, in accordance with some embodiments of the disclosure. Process 800 may be performed by physical or virtual control circuitry, such as control circuitry 418 of EVCS (FIG. 4), control circuitry 504 of user device (FIG. 5), and/or control circuitry 610 of server (FIG. 6). In some embodiments, some steps of process 800 may be performed by one of several devices.

At step 802, control circuitry receives an image of a tire of an electric vehicle. In some embodiments, the image of the tire is captured using one or more sensors of an electric vehicle charging station. For example, these sensors may be image (e.g., optical) sensors (e.g., one or more cameras 116), ultrasound sensors, depth sensors, IR cameras, RGB cameras, PIR cameras, heat IR, proximity sensors, radar, tension sensors, NFC sensors, and/or any combination thereof. In some embodiments, the image of the tire of the electric vehicle is transmitted due to an event (e.g., a device determining that a vehicle is within a vicinity of the device, a user requesting tire characteristic information, an electric vehicle requesting charging, etc.). In some embodiments, the image of the tire is received along with a request to charge an electric vehicle. In some embodiments, the request comprises information that identifies a user. For example, the user may input some credentials (e.g., password, pin, biometrics, device, item, etc.) when submitting the request. In some embodiments, the request is communicated to the control circuitry via a network. In some embodiments, the credentials are automatically inputted. For example, a user device can automatically transmit user credentials to the control circuitry when the user device is within a threshold distance of the control circuitry. In some embodiments, the control circuitry uses characteristics of the electric vehicle as credentials. For example, the control circuitry may automatically obtain characteristics of the electric vehicle using ISO 15118 when the user plugs in their electric vehicle.

At step 804, control circuitry determines a profile related to the electric vehicle, wherein the profile comprises vehicle information about the electric vehicle. In some embodiments, the profile stores information about the electric vehicle. For example, the profile may store information related to the user of the electric vehicle, vehicle information related to the electric vehicle, and/or similar such information. In some embodiments, the control circuitry determines the profile related to the electric vehicle using vehicle characteristics received from the one or more sensors. For example, control circuitry can automatically identify a profile related to the electric vehicle using vehicle characteristics obtained using ISO 15118. In some embodiments, the control circuitry uses information contained in the received image, and/or the request, to identify the profile related to the electric vehicle. For example, control circuitry can read a license plate (e.g., using optical character recognition) displayed in the received image and use the license plate information to identify the profile related to the electric vehicle. In some embodiments, the control circuitry uses credentials submitted by the user of the electric vehicle to identify a profile related to the electric vehicle. For example, the control circuitry may access a database (e.g., located on server 110) that associates the received information (e.g., credentials) with a user profile. In some embodiments, control circuitry determines the profile using vehicle characteristics, user information, and/or similar such information.

At step 806, control circuitry determines a tire characteristic of the tire using the received image. In some embodiments, a machine learning algorithm is used to determine the tire characteristic (e.g., depth of the tire tread) using the received image. In some embodiments, the machine learning algorithm is trained using a database comprising a plurality of tire images wherein the images indicate the depth and/or condition of the tire treads of the tires shown in the plurality of images.

In some embodiments, control circuitry uses the determined tire characteristic to determine a tire condition. In some embodiments, the control circuitry determines that a tire with a tire tread depth (tire characteristic) over six millimeters is in a “good” condition, a tire with a tire tread depth between six millimeters and three millimeters is in an “ok” condition, and a tire with a tire tread depth below three millimeters is in a “worn” condition and should be replaced soon. In some embodiments, using the determined tire characteristic (e.g., tire tread depth of two millimeters), the control circuitry determines that the tire in the received image is in a “worn” condition.

In some embodiments, control circuitry uses the profile to more quickly and/or accurately determine tire characteristics for an electric vehicle. For example, when an electric vehicle requests charging, control circuitry may receive tire characteristics associated with the electric vehicle from the last time the electric vehicle requested charging. The control circuitry can use the previous tire characteristics (e.g., tire type) to more quickly determine the condition of the tire because the control circuitry does not have to compare the electric vehicle's tire with different tire types.

At step 808, control circuitry notifies a user of the electric vehicle of the tire characteristic. In some embodiments, the notification is the notification shown in FIG. 1B or FIG. 2D. In some embodiments, the notification comprises one or more tire characteristics, tire conditions, suggestions, media items, etc. In some embodiments, the notification allows a user to quickly and easily discern their vehicle's tire condition. In some embodiments, the notification comprises information determined using the received image. For example, the control circuitry determines the tire type (e.g., 235/45R18 Michelin Primacy MXM4) of the tire in the received image using the size, pattern, texture, shape, DOT serial number, and/or tire identification number displayed in the received image. In some embodiments, the control circuitry uses information inputted by the user in conjunction with image information to generate the notification. In some embodiments, the control circuitry offers the user an option to correct information contained in the notification. In some embodiments, the control circuitry provides the notification with links to subsequent media items. For example, the control circuitry may include a notification with a link to a location that offers tire services for the electric vehicle.

At step 810, control circuitry updates the profile with the determined tire characteristic.

In some embodiments, control circuitry replaces an old tire characteristic (e.g., from a previous charging event) with the new tire characteristic determined in step 806. In some embodiments, control circuitry stores all the recorded tire characteristics for the electric vehicle to determine trends and patterns. In some embodiments, control circuitry updates the profile with any new vehicle information and/or user information.

At step 812, control circuitry determines an estimated travel distance traveled by the electric vehicle using the vehicle information and the determined tire characteristic. In some embodiments, control circuitry compares vehicle information (e.g., past tire tread depth) with the determined tire characteristic (e.g., current tire tread depth). In some embodiments, based on the comparison between the vehicle information (e.g., past tire tread depth) and the determined tire characteristic (e.g., current tire tread depth) the control circuitry can estimate a distance traveled by the electric vehicle during the time period between the two measurements. In some embodiments, control circuitry uses the estimated distance traveled to customize notifications and media items for the user of the electric vehicle. For example, if the control circuitry determines, based on the estimated amount of miles traveled by an electric vehicle, that the user of the electric vehicle will need to service their electric vehicle soon, the control circuitry can recommend that the user schedule a service appointment in the upcoming weeks. In some embodiments, the information stored in the profile can be used to determine user patterns, vehicle patterns, and/or location patterns. For example, control circuitry can determine that tire tread depth of profiles in a first geography decreases more quickly than tire tread depth of profiles in a second geography. In some embodiments, the determined patterns are used to further customize media items.

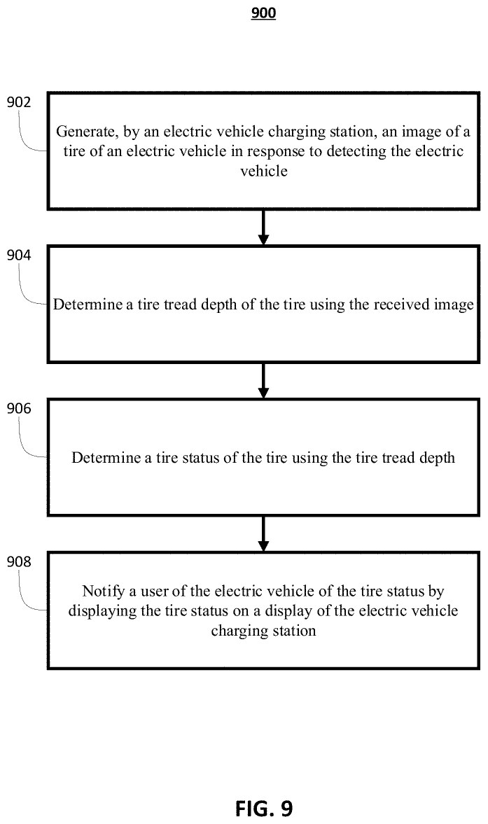

FIG. 9 is an illustrative flowchart of a process 900 for determining a tire characteristic of an electric vehicle's tire and notifying a user of the tire characteristic, in accordance with some embodiments of the disclosure. Process 900 may be performed by physical or virtual control circuitry, such as control circuitry 418 of EVCS (FIG. 4), control circuitry 504 of user device (FIG. 5), and/or control circuitry 610 of server (FIG. 6). In some embodiments, some steps of process 900 may be performed by one of several devices.

At step 902, control circuitry of an EVCS generates an image of a tire of an electric vehicle in response to detecting the electric vehicle. In some embodiments, the image of the tire is captured using one or more sensors of the EVCS. For example, these sensors may be image (e.g., optical) sensors (e.g., one or more cameras 116), ultrasound sensors, depth sensors, IR cameras, RGB cameras, PIR cameras, heat IR, proximity sensors, radar, tension sensors, NFC sensors, and/or any combination thereof In some embodiments, the image of the tire of the electric vehicle is transmitted due to an event (e.g., a device determining that the electric vehicle is within a vicinity of the device, a user requesting tire characteristic information, the electric vehicle requesting charging, etc.). In some embodiments, the image of the tire is received along with a request to charge an electric vehicle. In some embodiments, the request comprises information that identifies a user. For example, the user may input some credentials (e.g., password, pin, biometrics, device, item, etc.) when submitting the request. In some embodiments, the credentials are automatically inputted. For example, a user device can automatically transmit user credentials to the control circuitry when the user device is within a threshold distance of the control circuitry. In some embodiments, the control circuitry uses characteristics of the electric vehicle as credentials. For example, the control circuitry may automatically obtain characteristics of the electric vehicle using ISO 15118 when the user plugs in their electric vehicle.

At step 904, control circuitry determines a tire tread depth of the tire using the received image. In some embodiments, a machine learning algorithm is used to determine the depth of the tire tread using the received image. In some embodiments, the machine learning algorithm is trained using a database comprising a plurality of tire images, wherein the images indicate the depth and/or condition of the tire treads of the tires shown in the plurality of images.

In some embodiments, control circuitry uses a profile associated with the electric vehicle to more quickly and/or accurately determine tire tread depth for the electric vehicle. For example, when the electric vehicle requests charging, control circuitry may receive tire characteristics associated with the electric vehicle from the last time the electric vehicle requested charging. The control circuitry can use the previous tire characteristics (e.g., tire type) to more quickly determine the current depth of the tire tread because the control circuitry does not have to compare the electric vehicle's tire with different tire types.

At step 906, control circuitry determines a tire status of the tire using the tire tread depth. In some embodiments, the tire status corresponds to the tire condition. In some embodiments, the control circuitry determines that a tire with a tire tread depth (tire characteristic) over six millimeters is in a “good” condition, a tire with a tire tread depth between six millimeters and three millimeters is in an “ok” condition, and a tire with a tire tread depth below three millimeters is in a “worn” condition and should be replaced soon. In some embodiments, using the determined tire tread depth from step 904, the control circuitry determines that the tire in the received image is in a “worn” condition.

At step 908, control circuitry notifies a user of the electric vehicle of the tire status by displaying the tire status on a display of the EVCS. In some embodiments, the notification is the notification shown in FIG. 1B. In some embodiments, the notification comprises one or more tire characteristics, tire conditions, suggestions, media items, etc. In some embodiments, the notification allows a user to quickly and easily discern their vehicle's tire status. In some embodiments, the notification comprises information determined using the received image. For example, the control circuitry may determine the tire type (e.g., 235/45R18 Michelin Primacy MXM4) of the tire in the received image using the size, pattern, texture, shape, DOT serial number, and/or tire identification number displayed in the received image. In some embodiments, the control circuitry uses information inputted by the user in conjunction with image information to generate the notification. In some embodiments, the control circuitry offers the user an option to correct information contained in the notification. In some embodiments, the control circuitry provides the notification with links to subsequent media items. For example, the control circuitry may include a notification with a link to a location that offers tire services for the electric vehicle.

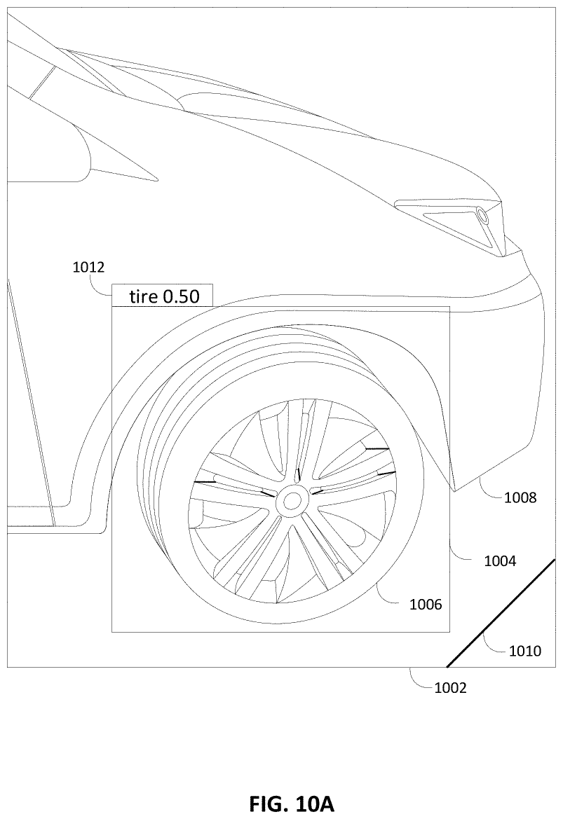

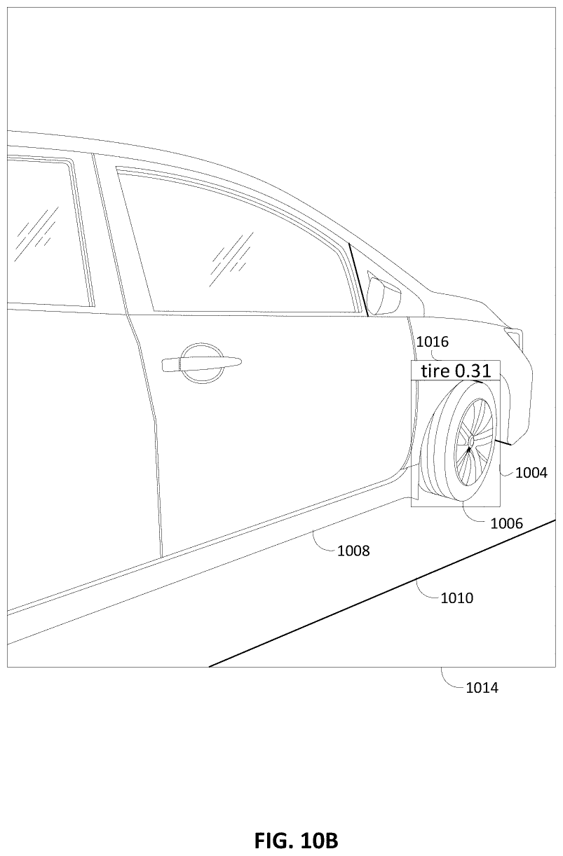

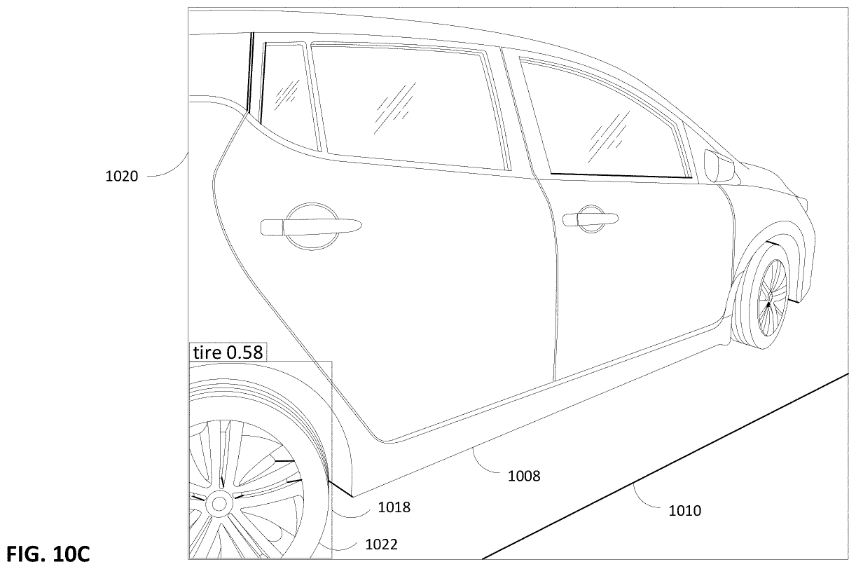

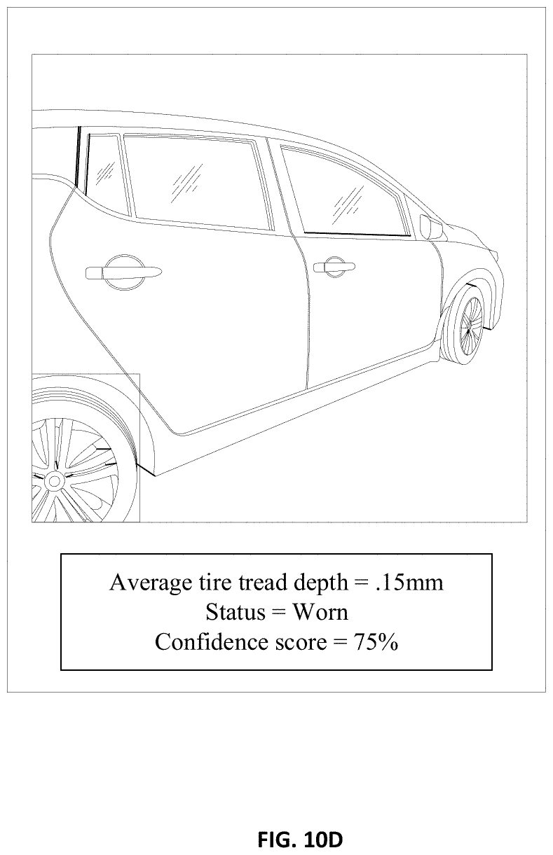

FIGS. 10A-10D show an illustrative process for determining a tire characteristic of an electric vehicle's tire and notifying a user of the tire characteristic, in accordance with some embodiments of the disclosure. In some embodiments, the FIGS. 10A-10D may demonstrate the user interface of a user device (e.g., user device 202) as the user device and/or server processes images of an electric vehicle. In some embodiments, FIGS. 10A-10D demonstrate processes executed at an EVCS (e.g., EVCS 400). In some embodiments, after receiving a first image 1002, a tire 1006 of an electric vehicle 1008 is identified (e.g., bounding box 1004). In some embodiments, the first image 1002 is received in response to the electric vehicle 1008 approaching or entering a parking space 1010. In some embodiments, a first estimated tire tread depth 1012 of the tire 1006 is determined using a machine learning algorithm. In some embodiments, the machine learning algorithm is trained using a database comprising a plurality of tire images, wherein the images indicate the depth and/or condition of the tire treads of the tires shown in the plurality of images.

In some embodiments, the tire tread depth is updated based on additional images. As shown in FIG. 10B, after receiving a second image 1014, a second estimated tire tread depth 116 is calculated. In some embodiments, an estimated tire tread depth is calculated for each received image. In some embodiments, the estimated tire tread depth measurements for each image are averaged to determine the tire tread depth. In some embodiments, each estimated tire tread depth is weighted according to a confidence score. For example, the first estimated tire tread 1012 depth may have a low confidence score and may not affect the tire tread calculation as much as the second estimated tire tread depth 1016 with a high confidence score.

In some embodiments, the tire tread depth calculation may change to a different tire. As shown in FIG. 10C, the second bounding box 1018 in a third image 1020 contains a second tire 1022, while the first bounding box 1004 in FIGS. 10A and 10B contain the first tire 1006. In some embodiments, the second tire 1022 may be preferred for image processing. In some embodiments, a single tire may be chosen for processing based on the parameters (e.g., quality, color, angle, skew, etc.) of the received images. For example, whichever tire is the clearest may be analyzed for tire characteristics. In some embodiments, more than one tire or all tires displayed in the image are analyzed for tire characteristics. In some embodiments, the tire selected for processing is based on the machine learning algorithm. For example, a machine learning algorithm may be trained using only the back tires of vehicles.

As shown in FIG. 10D, based on the received images, the tire condition is predicted to be “worn.” In some embodiments, this relates to all tires or a single tire. In some embodiments, the estimated tire tread depth measurements for each image are averaged to determine the tire tread depth. In some embodiments, each estimated tire tread depth is weighted according to a confidence score.

It is contemplated that some suitable steps or suitable descriptions of FIGS. 7-9 may be used with other suitable embodiments of this disclosure. In addition, some suitable steps and descriptions described in relation to FIGS. 7-9 may be implemented in alternative orders or in parallel to further the purposes of this disclosure. For example, some suitable steps may be performed in any order or in parallel or substantially simultaneously to reduce lag or increase the speed of the system or method. Some suitable steps may also be skipped or omitted from the process. Furthermore, it should be noted that some suitable devices or equipment discussed in relation to FIGS. 1A-6 could be used to perform one or more of the steps in FIGS. 7-9.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving, by an electric vehicle charging station, an image of a tire of an electric vehicle;
determining, by the electric vehicle charging station, a tire characteristic of the tire using the received image; and
notifying, by the electric vehicle charging station, a user of the electric vehicle of the tire characteristic.

2. The method of claim 1, wherein the tire characteristic corresponds to the condition of the tire.

3. The method of claim 1, further comprising determining, by the electric vehicle charging station, the condition of the tire using the tire characteristic, wherein the tire characteristic indicates the depth of the tire tread.

4. The method of claim 1, wherein notifying a user of the electric vehicle of the tire characteristic comprises displaying a notification on a display of the electric vehicle charging station.

5. The method of claim 1, wherein notifying the user of the electric vehicle of the tire characteristic comprises sending a notification to a device associated with the user.

6. The method of claim 1, wherein the electric vehicle charging station receives the image of the electric vehicle in response to detecting the electric vehicle.

7. The method of claim 1, wherein determining the tire characteristic of the tire using the received image is done using a machine learning algorithm.

8. The method of claim 1, further comprising:
determining, by the electric vehicle charging station, a profile related to the electric vehicle, wherein the profile comprises vehicle information about the electric vehicle;
updating, by the electric vehicle charging station, the profile with the determined tire characteristic; and
determining, by the electric vehicle charging station, an estimated distance traveled by the electric vehicle using the vehicle information and the determined tire characteristic.

9. The method of claim 1, further comprising:
receiving, by the electric vehicle charging station, a second image of the tire of the electric vehicle; and
updating the tire characteristic of the tire using the received second image.

10. An apparatus comprising:
control circuitry; and
at least one memory including computer program code for one or more programs, the at least one memory and the computer program code configured to, with the control circuitry, cause the apparatus to perform at least the following:
receive an image of a tire of an electric vehicle;
determine a tire characteristic of the tire using the received image; and
notify a user of the electric vehicle of the tire characteristic.

11. The apparatus of claim 10, wherein the tire characteristic corresponds to the condition of the tire.

12. The apparatus of claim 10, wherein the apparatus is further caused to determine the condition of the tire using the tire characteristic, wherein the tire characteristic indicates the depth of the tire tread.

13. The apparatus of claim 10, wherein the apparatus is further caused, when notifying a user of the electric vehicle of the tire characteristic, to display a notification on a display of the apparatus.

14. The apparatus of claim 10, wherein the apparatus is further caused, when notifying a user of the electric vehicle of the tire characteristic, to send a notification to a device associated with the user.

15. The apparatus of claim 10, wherein the apparatus is further caused to detect the electric vehicle and the apparatus receives the image of the electric vehicle in response to detecting the electric vehicle.

16. The apparatus of claim 10, wherein the apparatus is caused to determine the tire characteristic of the tire using a machine learning algorithm.

17. The apparatus of claim 10, wherein the apparatus is further caused to:
determine a profile related to the electric vehicle, wherein the profile comprises vehicle information about the electric vehicle;
update the profile with the determined tire characteristic; and
determine an estimated distance traveled by the electric vehicle using the vehicle information and the determined tire characteristic.

18. The apparatus of claim 10, wherein the apparatus is further caused to:
receive a second image of the tire of the electric vehicle; and
update the tire characteristic of the tire using the received second image.

19. A non-transitory computer-readable medium having instructions encoded thereon that when executed by control circuitry causes the control circuitry to:
receive an image of a tire of an electric vehicle;
determine a tire characteristic of the tire using the received image; and
notify a user of the electric vehicle of the tire characteristic.

20. The non-transitory computer-readable medium of claim 19, wherein the tire characteristic corresponds to the condition of the tire.

21.-51. (canceled)
